(19) United States
(12) Patent Application Publication
(10) Pub. No.: US 2009/0115801 A1
(43) Pub. Date: May 7, 2009

(54) ELECTRON EMISSION DISPLAY AND DRIVING METHOD THEREOF

(76) Inventor: Dong-Hyup Jeon, Suwon-si (KR)

Correspondence Address: CHRISTIE, PARKER & HALE, LLP, PO BOX 7068, PASADENA, CA, 91109-7068, US

(21) Appl. No.: 12/141,274

(22) Filed: Jun. 18, 2008

(30) Foreign Application Priority Data
Nov. 6, 2007 (KR) 10-2007-0112741

(51) Int. Cl. G09G 5/10; G09G 3/00

(52) U.S. Cl. 345/690; 345/30

(57) ABSTRACT

An electron emission display adapted to reduce or prevent non-uniformity of brightness between pixels and distortion of the white balance. The electron emission display includes a display region, a data driver, and a compensation unit. The display region has a plurality of pixels, each pixel comprising a plurality of sub-pixels. The data driver is coupled to the display region, and is configured to generate a data signal for driving the pixels to display an image. The compensation unit receives brightness data and image data, compensates the image data for a pixel, and outputs compensated image data to the data driver. To this end, the compensation unit includes a first compensation coefficient estimator and a second compensation coefficient estimator. The first compensation coefficient estimator receives brightness data of respective sub-pixels and estimates a plurality of first compensation coefficients such that the sub-pixels would emit the same brightness in response to the same data. The second compensation coefficient estimator estimates a second compensation coefficient commonly applied to the sub-pixels of the single pixel.

### CROSS-REFERENCE TO RELATED APPLICATION

This application claims priority to and the benefit of Korean Patent Application No. 10-2007-0112741, filed on Nov. 6, 2007, in the Korean Intellectual Property Office, the entire content of which is incorporated herein by reference.

### BACKGROUND OF THE INVENTION

1. Field of the Invention

The present invention relates to an electron emission display and a driving method thereof, with an improved image quality.

2. Description of Related Art

A flat panel display has a display region in which a plurality of pixels are arranged on a substrate in a matrix. Typically, a flat panel display displays an image by selectively applying image signals to the pixels through scanning lines and data lines coupled to the respective pixels.

The flat panel display may be used as a display of a portable information terminal such as a personal computer, a mobile phone, a personal digital assistant (PDA), or a monitor of various information devices. As examples of flat panel displays, a liquid crystal display uses a liquid crystal panel, an organic electroluminescent display uses organic light emitting devices, a plasma display panel usies a plasma panel, and an electron emission display uses electron emission devices.

In the above-mentioned flat panel displays, brightness differences occur between the respective pixels due to different manufacturing processes. Therefore, in order to reduce the brightness differences between the pixels, the brightness between the respective pixels may be compensated. However, when the brightness between the pixels is compensated, color coordinates of red, green, and blue pixels are changed so that the white balance may be distorted.

### SUMMARY OF THE INVENTION

Accordingly, it is an aspect of an exemplary embodiment of the present invention to provide an electron emission display in which brightness between respective pixels is compensated and distortion of the white balance is reduced or prevented, and a driving method thereof.

The foregoing and/or other aspects of an exemplary embodiment of the present invention are achieved by providing an electron emission display including a display region, a data driver, and a compensation unit. The display region has a plurality of pixels, each pixel including a plurality of sub-pixels, for example, red, green and blue (RGB) sub-pixels. The data driver is coupled to the display region, and configured to generate a data signal for driving the pixels to display an image. The compensation unit receives image data, compensates the image data utilizing brightness data from the sub-pixels, and outputs the compensated image data to the data driver. The compensation unit includes a first compensation coefficient estimator and a second compensation coefficient estimator. The first compensation coefficient estimator receives the brightness data of respective sub-pixels and estimates a plurality of first compensation coefficients such that the sub-pixels would emit the same brightness in response to inputs of the same data. The second compensation coefficient estimator utilizes the first compensation coefficients corresponding to the sub-pixels of a single pixel to estimate a second compensation coefficient, wherein the second compensation coefficient is commonly applied to the sub-pixels of the single pixel.

According to a further embodiment, the compensation unit includes a first compensation coefficient storage for storing the first compensation coefficients, and a second compensation coefficient storage for storing the second compensation coefficient.

In yet a further embodiment, the second compensation coefficient is a mean value of the first compensation coefficients corresponding to the sub-pixels of the single pixel. Alternatively, the second compensation coefficient is a middle value of the first compensation coefficients corresponding to the sub-pixels of the single pixel. In a further embodiment, the compensation unit also has a signal processor for receiving the image data and compensating the image data for the single pixel in response to the second compensation coefficient.

According to another exemplary embodiment, a method of driving an electron emission display including a display region having a plurality of pixels, includes obtaining brightness data from a plurality of sub-pixels of a pixel among the plurality of pixels, estimating a plurality of first compensation coefficients corresponding to the brightness data from the sub-pixels; estimating a second compensation coefficient utilizing the first compensation coefficients corresponding to the sub-pixels; and compensating an image signal for the pixel among the plurality of pixels in response to the second compensation coefficient.

The second compensation coefficient may be a mean value of the first compensation coefficients corresponding to the sub-pixels, or may be a middle value of the first compensation coefficients corresponding to the sub-pixels.

According to a further embodiment, the first and second compensation coefficients are stored in a first compensation coefficient storage and a second compensation coefficient storage, respectively. Further, the compensated image signal may be outputted to the data driver, wherein the data driver is coupled to the display region.

### BRIEF DESCRIPTION OF THE DRAWINGS

These and/or other embodiments and features of the invention will become apparent and more readily appreciated from the following description of certain exemplary embodiments, taken in conjunction with the accompanying drawings of which:

FIG. 1 is a block diagram illustrating an electron emission display according to an exemplary embodiment of the present invention;

FIG. 2 is a block diagram illustrating a compensation unit in FIG. 1; and

FIG. 3 is a flowchart illustrating operation of the compensation unit in FIG. 1.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some elements that may not be essential to obtain a complete understanding of the invention are omitted for clarity. Also, like reference numerals refer to like elements throughout.

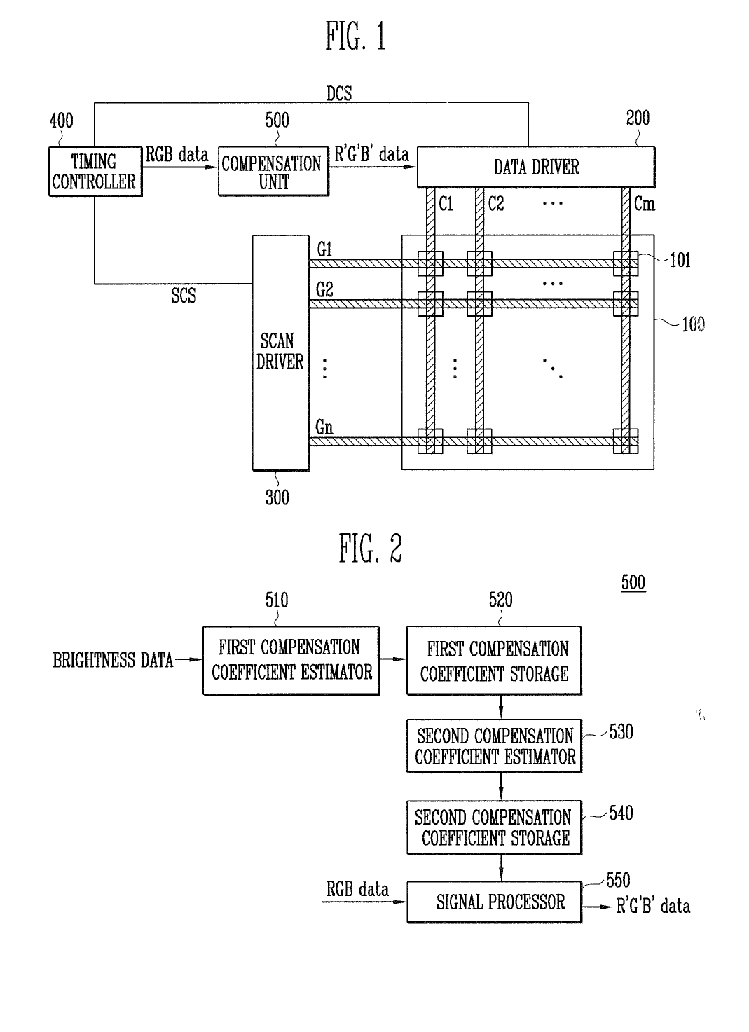

FIG. 1 is a block diagram illustrating an electron emission display according to an exemplary embodiment of the present invention. Referring to FIG. 1, the electron emission display includes a display region 100, a data driver 200, a scan driver 300, a timing controller 400, and a compensation unit 500.

According to this embodiment, the display region 100 includes pixels 101 formed where cathode electrodes C1, C2, . . . , Cm cross gate electrodes G1, G2, . . . , Gn. The pixels 101 display an image when electrons emitted from an electron emitting unit collide against the high voltage anode electrode to make phosphors emit light. Gray levels of the image displayed by the display region 100 are controlled according to a value of a digital image signal. In order to adjust the gray level displayed based on the value of the digital image signal, pulse width modulation may be used. Pulse width modulation is a method of controlling the gray level by controlling the amount of time that a data signal (with a voltage that may be predetermined) is applied to the cathode electrode. In more detail, pulse width modulation represents a high gray level when the data signal is applied for a long time, and represents a low gray level when the data signal is applied for a short time.

The data driver 200 creates the data signal using an image signal and is coupled with the cathode electrodes C1, C2, . . . , Cm. The data driver 200 transmits the data signal to the display region 100 via the cathode electrodes C1, C2, . . . , Cm such that the display region 100 emits light in response to the data signal. The data signal describes the gray levels utilizing pulse width modulation.

The scan driver 300 creates a scan signal and is coupled with the gate electrodes G1, G2, . . . , Gn. The scan driver 300 transmits the scan signal to the display region 100 via the gate electrodes G1, G2, . . . , Gn. The scan signal is transmitted to the display region 100 by the unit of a horizontal line for an appropriate amount of time (e.g., a predetermined time).

The timing controller 400 transmits the image signal (RGB data) and a data driver control signal DCS to the data driver 200, and transmits a scan driving control signal SCS to the scan driver 300. In other words, the timing controller 400 drives the data driver 200 and the scan driver 300 such that the display region 100 displays an image.

The compensation unit 500 stores compensation coefficients for respective pixels and compensates the image signal (RGB data) to be transmitted to the respective pixels using the compensation coefficients. The compensation unit 500 transmits the compensated image signal (R′G′B′ data) to the data driver 200. The compensation coefficients are estimated in response to a brightness difference between the respective pixels, and the respective pixels emit light at a substantially same brightness when identical image signals are transmitted thereto due to the compensation coefficients. Therefore, the compensated image signals (R′G′B′ data) are compensated by the compensation coefficients to reduce or prevent nonuniformity in the brightness of the respective pixels.

However, when the compensation coefficients are different for R-, G-, and B-sub-pixels in the compensation unit 500 and a range of compensating the brightness is changed, compensation levels are also changed by the R-, G-, and B-sub-pixels. Due to this, the white balance of the pixels may be distorted.

Therefore, in an exemplary embodiment of the present invention, the respective compensation coefficients of the R-, G-, and B-sub-pixels are estimated and intermediate values of the estimated compensation coefficients are employed. The brightness of the R-, G-, and B-sub-pixels is compensated to correspond to the employed intermediate values so that the brightness difference can be substantially uniform. By doing so, distortion of the white balance can be reduced or prevented.

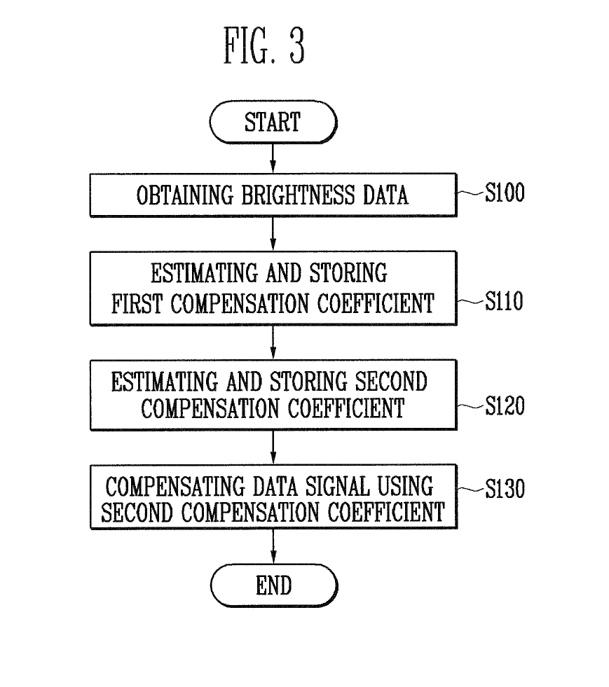

FIG. 2 is a block diagram illustrating an exemplary embodiment of a compensation unit 500 in FIG. 1. Referring to FIG. 2, the compensation unit 500 includes a first compensation coefficient estimator 510, first compensation coefficient storage 520, a second compensation coefficient estimator 530, second compensation coefficient storage 540, and a signal processor 550.

The first compensation coefficient estimator 510 is a device for estimating a first compensation coefficient corresponding to the R-, G-, and B-sub-pixels and receives brightness data to estimate the first compensation coefficient.

For example, the first compensation coefficient estimator 510 performs an operation to estimate the first compensation coefficients listed in Table 2 when data inputted to the respective sub-pixels is 255 and brightness data displayed by the respective sub-pixels are those listed in Table 1. The brightness data is obtained by using a brightness measuring device such as a light sensor, as those skilled in the art would appreciate. The present invention is not limited to any particular method of measuring brightness.

TABLE 1
Brightness Data

| R-sub-pixel | G-sub-pixel | B-sub-pixel |
|---|---|---|
| 210 | 205 | 215 |
| 220 | 215 | 205 |
| 210 | 230 | 255 |

TABLE 2
First Compensation Coefficients

| R-sub-pixel | G-sub-pixel | B-sub-pixel |
|---|---|---|
| 0.976 | 1 | 0.953 |
| 0.931 | 0.953 | 1 |
| 0.976 | 0.891 | 0.803 |

Referring to Tables 1 and 2, when the respective sub-pixels receive the same data 255, the respective sub-pixels emit the brightness as listed in Table 1 due to the non-uniformity of brightness caused by process variations. As such, when the respective sub-pixels emit different brightnesses, a spot appears on a screen and image quality is deteriorated.

Therefore, in order for the respective sub-pixels to have substantially the same brightness with respect to same data signal, the brightness compensation is carried out based on a minimum brightness. In more detail, referring to Table 1, since the maximum brightness is 255 and the minimum brightness is 205, the first compensation coefficients are set as listed in Table 1 such that all of the sub-pixels are set to emit the brightness of 205. The first compensation coefficients are stored in the first compensation coefficient storage 520.

However, if the compensation coefficients in Table 2 are directly applied to compensate the data signals, the compensation levels become different by the R-, G-, and B-sub-pixels. Due to this, the color coordinate becomes different from that of the non-compensated image signal in a single pixel including the R-, G-, and B-sub-pixels, so that the white balance is distorted.

Therefore, in order to reduce or prevent the distortion of the white balance, an intermediate value of the first compensation coefficients of the R-, G-, and B-sub-pixels which are included in the single pixel is extracted. The image signal is compensated by the extracted intermediate value. When the image signal is compensated by the intermediate value, the difference between the compensation levels of brightness is reduced by the R-, G-, and B-sub-pixels so that distortion of the white balance can be reduced or prevented. The intermediate value of the first compensation coefficients is referred to as a second compensation coefficient.

The second compensation coefficient estimator 530 operates on the first compensation coefficients stored in the first compensation coefficient storage 520 to estimate the second compensation coefficients corresponding to the respective pixels including the R-, G-, and B-sub-pixels. In other words, the second compensation coefficient estimator 530 estimates the intermediate value of the first compensation coefficients corresponding to the R-, G-, and B-sub-pixels included in the single pixel and sets the estimated value as the second compensation coefficient. The intermediate value referred to may be a mean value of the first compensation coefficients or a middle value among the first compensation coefficients. That is, in an exemplary embodiment including three sub-pixels per pixel, the middle value may be the value of the first compensation coefficient that is in between the first compensation coefficients of the other two sub-pixels. In another exemplary embodiment, the middle value may be a value between the highest and the lowest of three first compensation coefficients. The second compensation coefficient estimated by the second compensation coefficient estimator 530 is stored in the second compensation coefficient storage 540.

The signal processor 550 uses the second compensation coefficient stored in the second compensation coefficient storage 540 to compensate the image signal (RGB data) transmitted from the timing controller 400. The signal processor 550 supplies the compensated image signals (R′G′B′ data) to the data driver 200. By doing so, the data driver 200 creates data signals corresponding to the compensated image signals (R′G′B′ data) and transmits the same to the display region 100.

FIG. 3 is a flowchart illustrating operation of an exemplary embodiment of the compensation unit in FIG. 1. Referring to FIG. 3, in a first operation (S100), data signals are received to make the respective sub-pixels of the display region 100 emit light to obtain brightness data of the respective sub-pixels.

In a second operation (S110), the first compensation coefficients are estimated using the brightness data and the estimated first compensation coefficients are stored. The first compensation coefficients are assigned with a value in which the respective sub-pixels emit substantially the same brightness by reducing the brightness of bright sub-pixels based on the darkest sub-pixels.

In a third operation (S120), the second compensation coefficients are estimated and stored. The second compensation coefficients are estimated using the first compensation coefficients corresponding to a plurality of the sub-pixels included in a single pixel. The reason for estimating the second compensation coefficients is because the difference between the compensation levels of the sub-pixels may be large when the image signal is compensated using the first compensation coefficients.

The estimation of the second compensation coefficients will be described in more detail. After obtaining the first compensation coefficients corresponding to the plurality of sub-pixels included in a single pixel, the mean value of the first compensation coefficients or the intermediate value of the first compensation coefficients is obtained and the obtained first compensation coefficients are set to the second compensation coefficients. Since the second compensation coefficients are the mean values of the first compensation coefficients or values positioned at the middle of the first compensation coefficients, the compensation difference between the image signals inputted to the respective sub-pixels is reduced. Therefore, it is possible to reduce or prevent distortion of the white balance.

In a fourth operation (S130), the inputted image signal is compensated using the stored second compensation coefficients. The image signal compensated by the compensation unit is transmitted to the data driver so that the compensated result can be reflected to the data signal.

According to the electron emission display and the driving method thereof in accordance with the present invention, non-uniformity between pixels is reduced or prevented and the distortion of the white balance of the pixels is also reduced or prevented.

Although exemplary embodiments of the present invention have been shown and described, it would be appreciated by those skilled in the art that changes might be made to these embodiments without departing from the principles and spirit of the invention, the scope of which is defined in the claims and their equivalents.

What is claimed is:

1. An electron emission display comprising:
a display region comprising a plurality of pixels, each pixel comprising a plurality of sub-pixels;
a data driver coupled to the display region and configured to generate a data signal for driving the pixels to display an image; and
a compensation unit for receiving brightness data and image data, compensating the image data for a pixel, and outputting compensated image data to the data driver, the compensation unit comprising:
a first compensation coefficient estimator for receiving the brightness data of respective sub-pixels and for estimating a plurality of first compensation coefficients such that the sub-pixels would emit a substantially same brightness in response to same data; and
a second compensation coefficient estimator for utilizing the first compensation coefficients corresponding to the sub-pixels of a single pixel of the plurality of pixels to estimate a second compensation coefficient, wherein the second compensation coefficient is commonly applied to the sub-pixels of the single pixel.

2. The electron emission display as claimed in claim 1, wherein the compensation unit further comprises:
a first compensation coefficient storage for storing the first compensation coefficients; and
a second compensation coefficient storage for storing the second compensation coefficient.

3. The electron emission display as claimed in claim 1, wherein the second compensation coefficient comprises a mean value of the first compensation coefficients corresponding to the sub-pixels of the single pixel.

4. The electron emission display as claimed in claim 1, wherein the second compensation coefficient comprises a middle value of the first compensation coefficients corresponding to the sub-pixels of the single pixel.

5. The electron emission display as claimed in claim 2, wherein the compensation unit further comprises a signal processor for receiving the image data and compensating the image data for the single pixel in response to the second compensation coefficient.

6. A method of driving an electron emission display comprising a display region having a plurality of pixels, the method comprising:
obtaining brightness data from a plurality of sub-pixels of a pixel among the plurality of pixels;
estimating a plurality of first compensation coefficients corresponding to the brightness data from the sub-pixels;
estimating a second compensation coefficient utilizing the first compensation coefficients corresponding to the sub-pixels; and
compensating an image signal for the pixel among the plurality of pixels in response to the second compensation coefficient.

7. The method of driving an electron emission display as claimed in claim 6, wherein the second compensation coefficient comprises a mean value of the first compensation coefficients corresponding to the sub-pixels.

8. The method of driving an electron emission display as claimed in claim 6, wherein the second compensation coefficient comprises a middle value of the first compensation coefficients corresponding to the sub-pixels.

9. The method of driving an electron emission display as claimed in claim 6, further comprising:
storing the first compensation coefficients in a first compensation coefficient storage; and
storing the second compensation coefficient in a second compensation coefficient storage.

10. The method of driving an electron emission display as claimed in claim 6, further comprising outputting a compensated image signal to a data driver, the data driver coupled to the display region.
